(19) United States
(12) Patent Application Publication
(10) Pub. No.: US 2015/0077560 A1
(43) Pub. Date: Mar. 19, 2015

(54) FRONT CURB VIEWING SYSTEM BASED UPON DUAL CAMERAS

(71) Applicant: GM Global Technology Operations LLC, Detroit, MI (US)

(72) Inventors: WENDE ZHANG, Troy, MI (US); JINSONG WANG, Troy, MI (US); KENT S. LYBECKER, Rochester, MI (US)

(21) Appl. No.: 14/210,843

(22) Filed: Mar. 14, 2014

Related U.S. Application Data
(60) Provisional application No. 61/804,485, filed on Mar. 22, 2013.

(51) Int. Cl. B60R 1/00; H04N 7/18

(52) U.S. Cl. CPC B60R 1/00; H04N 7/181
USPC 348/148

(57) ABSTRACT

Methods and systems are provided for generating a curb view virtual image to assist a driver of a vehicle. The method includes capturing a first and second real image from a first and second camera having a forward-looking field of view. The first and second images are de-warped and combined to form a curb view virtual image view of the vehicle, which is displayed on display within the vehicle. The system includes a first and second camera having a forward-looking field of view to provide a first and second real image. A processor coupled to the first camera and the second camera configured to de-warps and combines the first and second real images to form a curb view virtual image view for display within the vehicle. The curb view virtual image may be a top-down virtual image view or a perspective virtual image view.

### RELATED APPLICATION

This application claims the benefit of U.S. Provisional Application No. 61/804,485 filed Mar. 22, 2013.

### TECHNICAL FIELD

The technical field generally relates to camera based driver assistance systems, and more particularly relates to camera based imaging of a front bumper of a vehicle relative to a curb or other obstruction.

### BACKGROUND

Many modern vehicles include sophisticated electronic systems designed to enhance the safety, comfort and convenience of the occupants. Among these systems, driver assistance systems have become increasing poplar as these systems afford the operator of the vehicle information about avoiding damage to the vehicle and/or obstacles that the vehicle might otherwise collide with. For example, many contemporary vehicles have a rear-view camera to assist the operator of the vehicle with backing out of a driveway or parking space.

Forward facing camera systems have also been employed for vision based collision avoidance systems and clear path detection systems. However, such systems generally utilize a single camera system having a relatively narrow field of view (FOV) and are not suited for assisting an operator of a vehicle in parking the vehicle while avoiding damage to the front bumper or grill of the vehicle. In vehicles with a sports car body type, the front bumper is much closer to the road/ground, and may be more prone to incurring cosmetic or structural damage to the front bumper while parking. This can lead to customer dissatisfaction as plastic or composite front bumper and/or grill assemblies can be expensive to replace.

Accordingly, it is desirable to provide parking assistance to an operator of a vehicle. In addition, it is desirable to assist the operator in avoiding damage to the front bumper of the vehicle while parking. Furthermore, other desirable features and characteristics of the present invention will become apparent from the subsequent detailed description and the appended claims, taken in conjunction with the accompanying drawings and the foregoing technical field and background.

### SUMMARY

A method is provided for generating a curb view virtual image to assist a driver of a vehicle. The method includes capturing a first real image from a first camera having a forward-looking field of view of a vehicle and capturing a second real image from a second camera having a forward-looking field of view of the vehicle. The first and second images are de-warped and combined in a processor to form a curb view virtual image view in front of the vehicle. The curb view virtual image may be a top-down virtual image view or a perspective image view, which is displayed on a display within the vehicle.

A system is provided for generating a curb view virtual image to assist a driver of a vehicle. The system includes a first camera having a forward-looking field of view of a vehicle to provide a first real image and a second camera having a forward-looking field of view of the vehicle to provide a second real image. A processor coupled to the first camera and the second camera and configured to de-warp and combine the first real image and the second real image to form a curb view virtual image view of a front area of the vehicle. A display for displaying the curb view virtual image is positioned within the vehicle.

### DESCRIPTION OF THE DRAWINGS

The exemplary embodiments will hereinafter be described in conjunction with the following drawing figures, wherein like numerals denote like elements, and wherein:

FIG. 1 is a top view illustration of a vehicle in accordance with an embodiment;

FIGS. 2A and 2B are side view illustrations of the vehicle of FIG. 1 in accordance with an embodiment;

FIG. 3 is a block diagram of an image processing system in accordance with an embodiment;

FIG. 4 is an illustration of top-down view de-warping and stitching in accordance with an embodiment;

FIGS. 5A-5D are graphic images illustrating top-down view de-warping and stitching in accordance with an embodiment;

FIG. 6A is an illustration of a non-planar pin-hole camera model in accordance with an embodiment;

FIG. 6B is an illustration and graphic images of input/output imaging for the non-planar model in accordance with an embodiment;

FIG. 7 is an illustration showing a combined planar and non-planar de-warping technique in accordance with an embodiment;

FIGS. 8A and 8B illustrate the technique of FIG. 7 applied to the dual camera system in accordance with an embodiment;

FIGS. 9A and 9B illustrate a merged view of the dual camera system of FIGS. 8A and 8B in accordance with another embodiment; and

FIG. 10 is a flow diagram illustrating a method in accordance with another embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

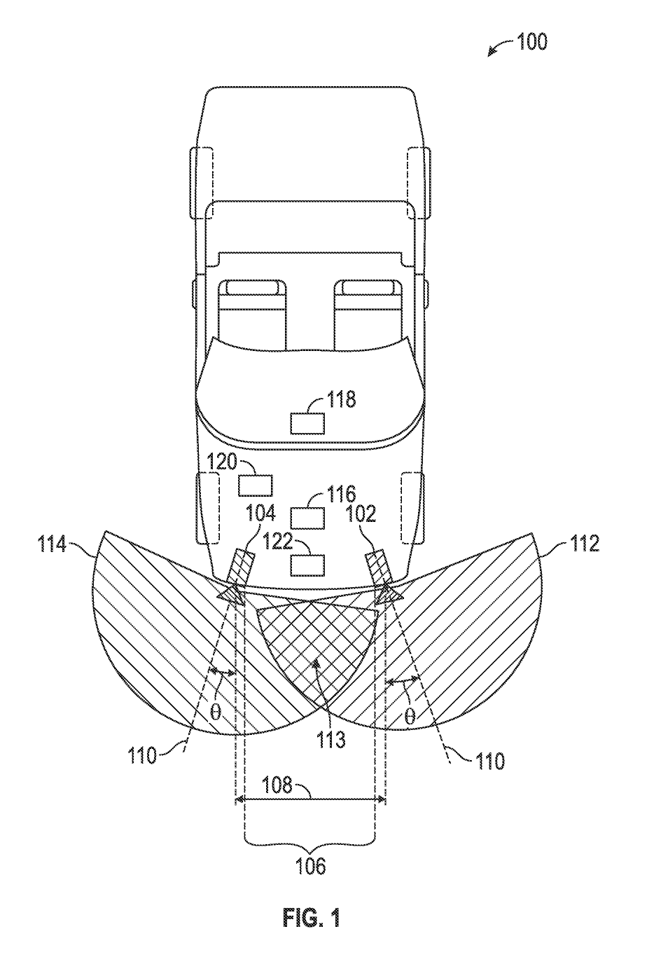

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-9 are merely illustrative and may not be drawn to scale.

FIG. 1 is a top plan view of a vehicle 100 according to an embodiment. The vehicle 100 includes a pair of cameras 102, 104 positioned behind the grill or in the front bumper of the vehicle 100. The first (or left) camera 102 is spaced apart by a distance 106 from the second (or right) camera 104. The distance 106 will vary depending upon the make and model of the vehicle 100, but in some embodiments may be approximately one meter. In some embodiments, the cameras 102 and 104 have an optical axis 108 aligned with a forward direction of the vehicle 100, while in other embodiments the cameras 102, 104 have an optical axis 110 that is offset from the forward direction of the vehicle by a pan angle θ. The angle employed may vary depending upon the make and model of the vehicle, but in some embodiments is approximately 10°. Whatever orientation is selected for the cameras 102 and 104, each camera captures an ultra-wide field of view (FOV) using a fish-eye lens to provide approximately a 180° FOV that partially overlaps 113. The images captured by the cameras 102,104 may be processed in a controller 116 having image processing hardware and/or software as will be discussed below, to provide one or more types of driver assisting images on a display 118.

Optionally, the vehicle 100 may have other driver assistance systems such as a route planning and navigation system 120 and/or a collision avoidance system 122. The route planning and navigation system 120 may employ a Global Positioning System (GPS) based system to provide location information and data used for route planning and navigation. The collision avoidance system may employ one or more conventional technologies. Non-limiting examples of such conventional technologies include systems that are vision-based, ultrasonic, radar based and light based (i.e., LIDAR).

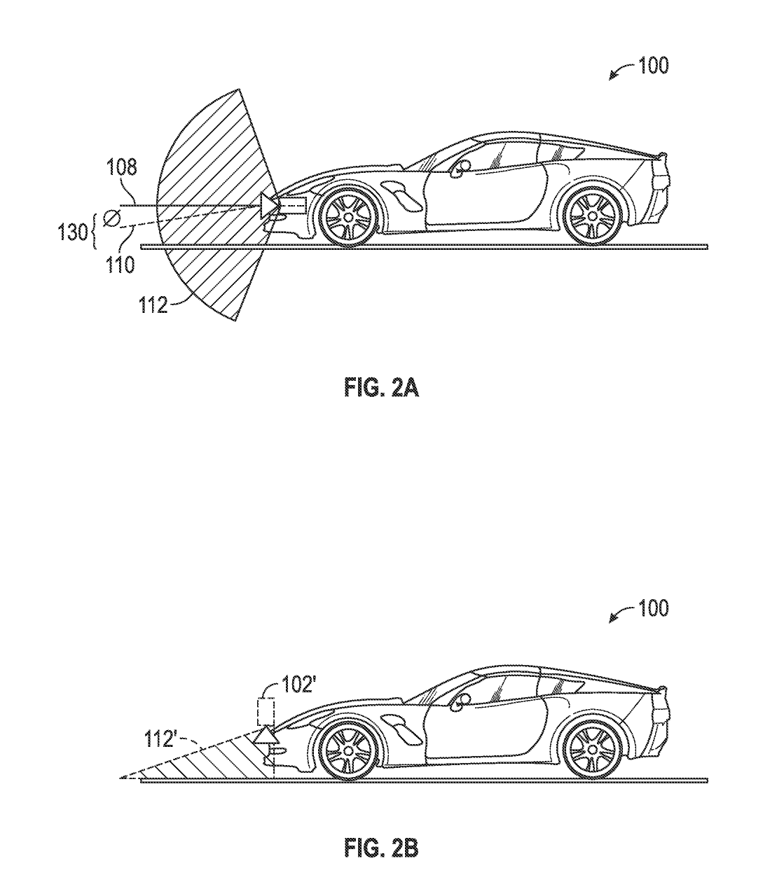

FIGS. 2A and 2B illustrate side views of the vehicle 100. The left camera 102 is shown positioned by a distance 130 above the road/ground. The distance 130 will depend upon the make and model of the vehicle 100, but in some embodiments is approximately one-half meter. Knowing the distance 130 is useful for computing virtual images from the field of view 112 to assist the driver of the vehicle 100. The camera 102 (and camera 104 on the opposite side of the vehicle) may be vertically aligned with the forward direction 108 of the vehicle, or may be in some embodiments, slightly angled downward by a tilt angle φ to provide field of view 112. The angle φ will vary by make and model of the vehicle, but in some embodiments may be in a range of approximately 0° to 10°.

According to exemplary embodiments, the present disclosures affords the advantage of providing driver assisting images of the area adjacent to or around the front bumper of the vehicle (i.e., curb view) using one or more virtual imaging techniques. This provides the driver with virtual images of curbs, obstacles or other objects that the driver may want to avoid. As used herein, “a curb view virtual image” means a virtual image of the area in front of the vehicle based upon dual real images obtained by forward looking cameras mounted to the vehicle. The curb view may be a top-down view, a perspective view or other views depending upon the virtual imaging techniques or camera settings as will be discussed below. As can be seen in FIG. 2B, the virtual imaging provided by the disclosed system presents the driver with images from a virtual camera 102′ having a virtual FOV 112′. The term “virtual camera” is a simulated camera 102′ with simulated camera model parameters and simulated imaging FOV 112′, in addition to a simulated camera pose. The camera modeling may be performed by processor or multiple processors employing hardware and/or software. The term “virtual image” is a synthesized image of a scene using the virtual camera modeling. In this way, a vehicle operator may view a curb or other obstruction in front of the vehicle when parking the vehicle and may avoid damage to the vehicle by knowing when to stop forward movement of the vehicle.

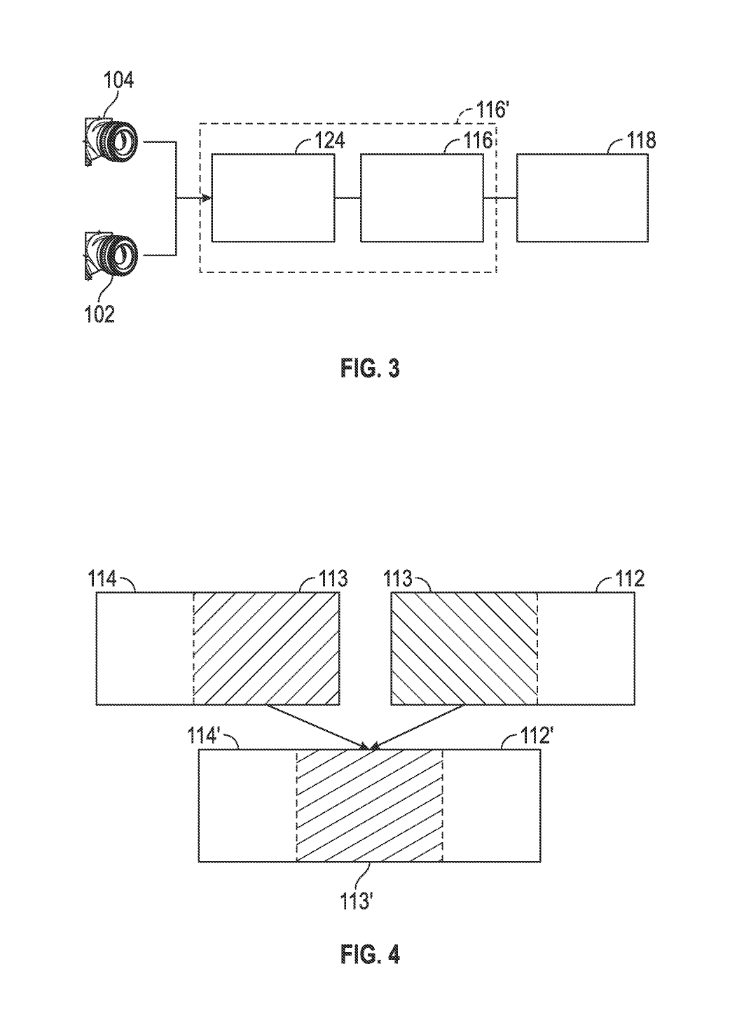

FIG. 3 is a block diagram of the image processing system employed by various embodiments. The cameras 102, 104 may be any camera suitable for the purposes described herein, many of which are known in the automotive art, that are capable of receiving light, or other radiation, and converting the light energy to electrical signals in a pixel format using, for example, charged coupled devices (CCD). The cameras 102, 104 generate frames of image data at a certain data frame rate that can be streamed for subsequent processing. According to exemplary embodiments, the cameras 102, 104 each provide ultra-wide FOV images to a video processing module 124 (in a hardware embodiment), which in turn provides virtual images to the controller 116 for presentation via the driver display 118. In some hardware embodiments, the video processing module may be a stand-alone unit or integrated circuit or may be incorporated into the controller 116′. In software embodiments, the video processing module 124 may represent a video processing software routine that is executed by the controller 116′.

Since the images provided by the cameras 102, 104 have an ultra-wide FOV (i.e., fish-eye views) the images will be significantly curved. For the images to be effective for assisting the driver of the vehicle, these distortions must be corrected and/orthe images enhanced so that the distortions do not significantly degrade the image. Disclosed herein are various virtual camera modeling techniques employing planar (perspective) de-warping and/or non-planar (e.g., cylindrical) de-warping to provide useful virtual images to the operator of the vehicle.

Merged Top-Down Curb View

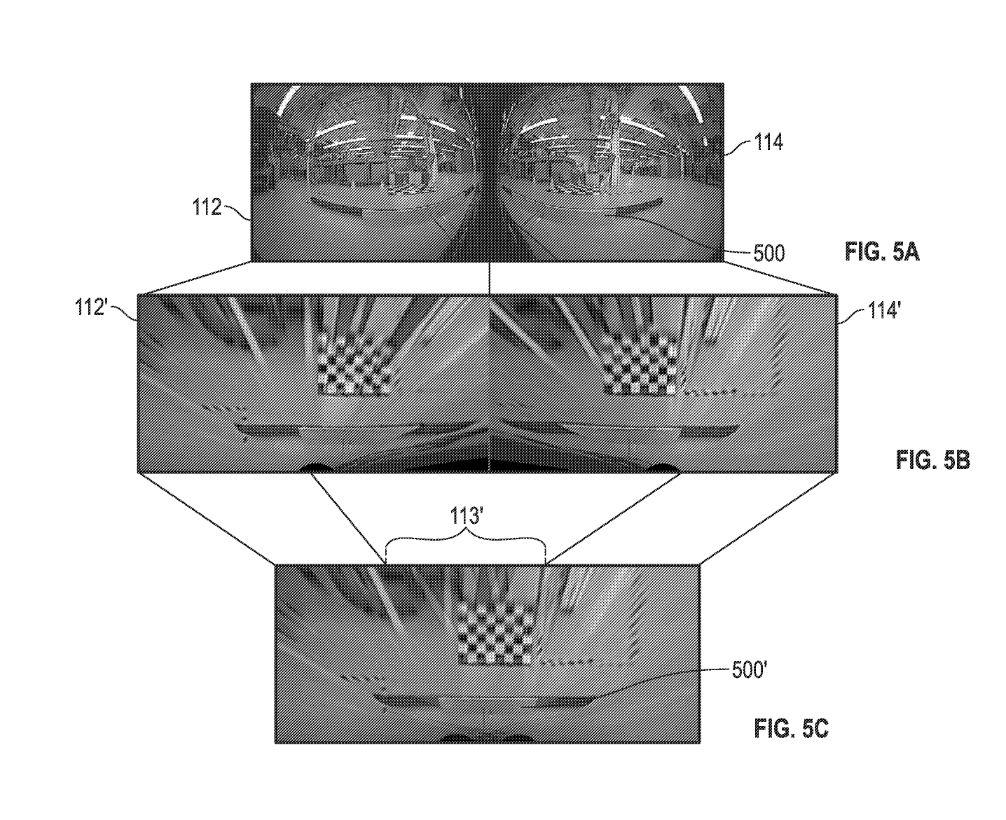

FIG. 4 illustrates a planar or perspective de-warping technique that may be utilized to provide the driver with a top-down virtual view of the area adjacent to or around the front bumper of the vehicle. This provides the driver with virtual images of curbs, obstacles or other objects that the driver may want to avoid. The FOV 112 provided by the first (left) camera 102 and the FOV 114 provided by the second (right) camera 104 have the overlapping region 113 merged to provide a single top-down curb view virtual image for the vehicle 100. While several image merging or stitching techniques exist, in some embodiments, the merged overlapping region 113′ is created via a weighted averaging technique that assigns a weight to each pixel in the overlapping regions 113 based upon difference between the angle and distance offsets as follows:

Define: W_{img}, topdown-view image width; Wₒᵥₑᵣₗₐₚ, overlap region width;
x_{offset}=W_{img}−Wₒᵥₑᵣₗₐₚ, offset of the overlap region in left image

$${w}_{left} ( i ) = \{ \begin{matrix}1 , & if i \leq {x}_{offset} \\ 1 - \frac{i - {x}_{offset}}{{W}_{overlap}} , & i > {x}_{offset}\end{matrix} , \\ {w}_{right} ( j ) = \{ \begin{matrix}\frac{j}{{W}_{overlap}} & if j \leq {W}_{overlap} \\ 1 , & j > {W}_{overlap}\end{matrix} ,$$

Non-overlap region:

$${p}_{merge} ( k ) = \{ \begin{matrix}{p}_{left} ( k ) , & if k \leq {x}_{offset} \\ {p}_{right} ( k - {x}_{offset} ) , & if k > {W}_{img}\end{matrix} ,$$

Overlap region: x_{offset}<k≦W_{img}

p_{merge}(k)=w_{left}(k)·p_{left}(k)+w_{right}(k−x_{offset})·p_{right}(k−x_{offset})

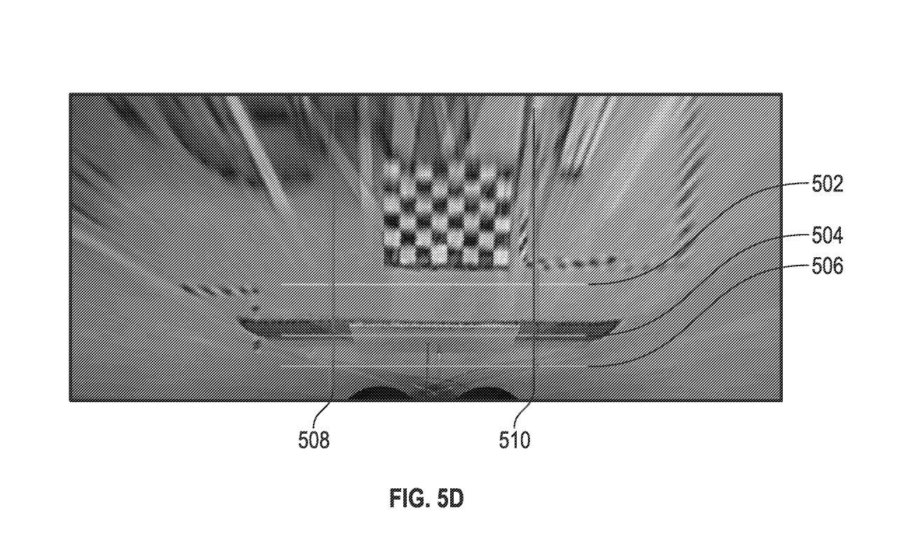

FIGS. 5A-5C illustrates images process according to the top-downde-warping and stitching technique. In FIG. 5, a curb 500 is seen in the FOV 112 and 114. The images are curved (or warped) due to the ultra-wide FOVs provided by the cameras 102, 104 as discussed above. After processing, the top-down virtual images 112′ and 114′ can be seen in FIG. 5B as somewhat blurred, however, still offering a useful view of the curb. After the overlapping regions are merged (stitched) as discussed above, the merged region 113′ provides the driver of the vehicle with a top-down merged view of the curb 500′ in FIG. 5C so that the operator of the vehicle may park without impacting the curb. Optionally, various graphic overlays applied to the image to assist the driver. As one non-limiting example, FIG. 5D illustrates three horizontal lines 502, 504 and 506 to provide distance information to the driver. For example, line 502 may represent a distance of one meter in front of the bumper of the vehicle and may be displayed in a green color indicating a safe distance away. Line 504 may represent a distance of 0.5 meters away and may be colored yellow or orange to indicate provide a warning to the driver, while line 506 may represent a distance of 0.2 meters ahead of the bumper and may be colored red to indicate the minimum recommended distance for stopping. Additionally, vertical lines 508, 510 may be provided to indicate the width of the vehicle for the assistance of the driver. As will be appreciated, any number of other graphic overlays are possible for and may be displayed (or not) as selected by the user (e.g., in a system settings menu) and may be automatically activated when the system is activated or may be manually activated by the driver (e.g., switch, button or voice command).

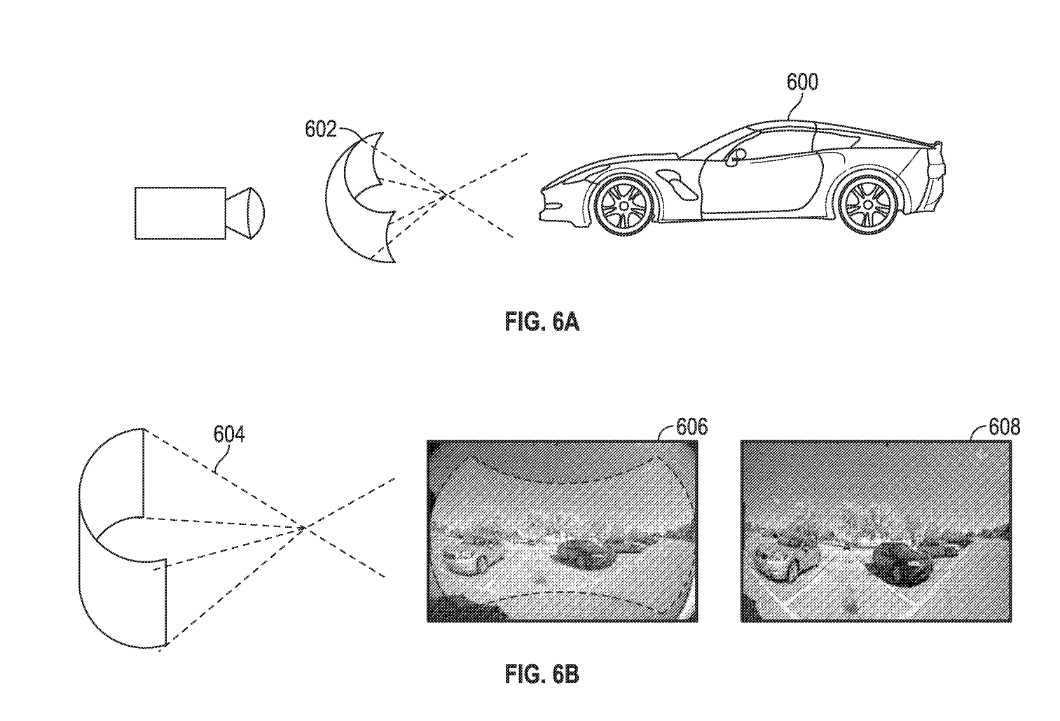

FIG. 6A illustrates a preferred technique for synthesize a virtual view of the captured scene 600 using a virtual camera model with non-planar image surface. The incident ray of each pixel in the captured image 600 is calculated based on the camera model and radial distortion of the real capture device. Then the incident ray is projected on to a non-planar image surface 602 through the virtual camera (pin-hole) model to get the pixel on the virtual image surface.

To have the image surface laid out flat to get the synthesized virtual image, a view synthesis technique is applied to the projected image on the non-planar surface for de-warping the image. In FIG. 6B, image de-warping is achieved using a concave image surface 604. Such surfaces may include, but is not limited to, a (circular) cylinder and a elliptical cylinder image surfaces. That is, the captured scene 606 is projected onto a cylindrical like surface 604 using the pin-hole model as described above. Thereafter, the image projected on the cylinder image surface is laid out (de-warped) on the flat in-vehicle image display device as shown in FIG. 6B.

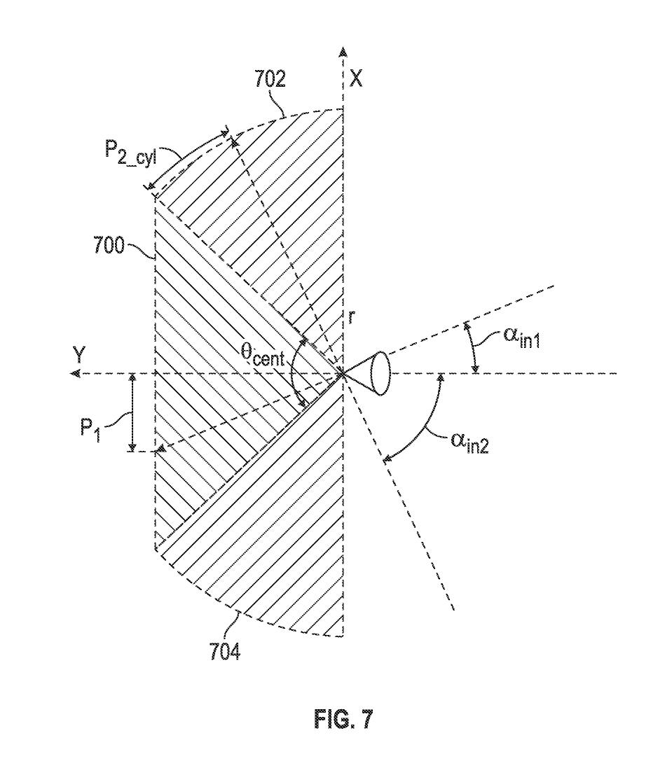

FIG. 7 is an illustration showing a cross-section of a combined planar and non-planar image de-warping. According to exemplary embodiments, a center region 700 of a virtual image is modeled according to the planar or perspective technique. The size of the center region 700 may vary in different implementations, however, in some embodiments may be approximately 120°. The side portions 702, 704 are modeled using the non-planar (cylindrical) technique, and the size of those portions will depend upon the size selected for the center region 700 (i.e., 30° if the center region is 120°). Mathematically, this combined de-warping technique can be expressed as:
center (within θ_{cent}): rectilinear projection,
both sides (out of θ_{cent}): cylindrical projection
If

$$abs ( {α}_{in} ) \leq \frac{{θ}_{cent}}{2} ,$$

center (within θ_{cent})
Rectlinear Projection:

$${P}_{1} = {u}_{virt} - {u}_{0} = {f}_{u}^{′} \cdot tan ( {α}_{in 1} ) = {f}_{u} \cdot cos ( \frac{{θ}_{cent}}{2} ) \cdot tan ( {α}_{in 1} )$$

else

$$abs ( {α}_{in} ) > \frac{{θ}_{cent}}{2} ,$$

both sides (out of θ_{cent})
Cylindrical Projection:

$$\begin{matrix}{P}_{2} = {u}_{virt} - {u}_{0} \\ = {P}_{cent\_hf} + arc ( {P}_{2 \_cyl} ) \\ = sign ( {α}_{in 2} ) \cdot ( {f}_{u} \cdot sin ( \frac{{θ}_{cent}}{2} ) + {f}_{u} \cdot ( abs ( {α}_{in 2} ) - \frac{{θ}_{cent}}{2} ) )\end{matrix}$$

Perspective Curb View

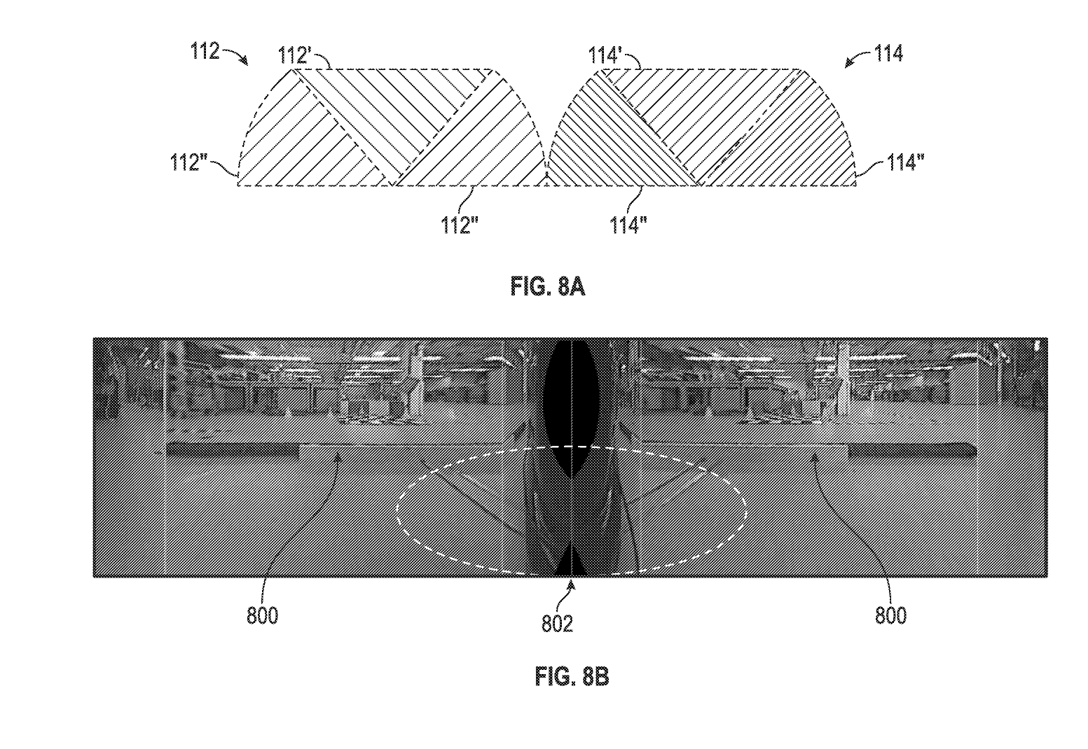

FIG. 8A is an illustration showing the combined technique of FIG. 7 applied to the dual camera 102, 104 of the present disclosure to provide a perspective view of a curb 800 (or other frontal obstruction) as viewed through each of the cameras 102 and 104. The FOV 112 from the left camera 102 is process according to the modeling technique of FIG. 7 resulting in a planar de-warped central region 112′ and two cylindrically de-warped side regions 112″. Similarly, the FOV 114 from the right camera 104 is process according to the modeling technique of FIG. 7 resulting in a planar de-warped central region 114′ and two cylindrically de-warped side regions 114″. According to this embodiment, the virtual FOVs 112 and 114 would be displayed (via display 118 of FIG. 1) in a side-by-side manner as shown in FIG. 8B. This provides a driver with a sharp (as opposed to the slightly blurred image offered by just top-down view de-warping) virtual image with no missing segments in front of the curb 800.

Merged Perspective Curb View

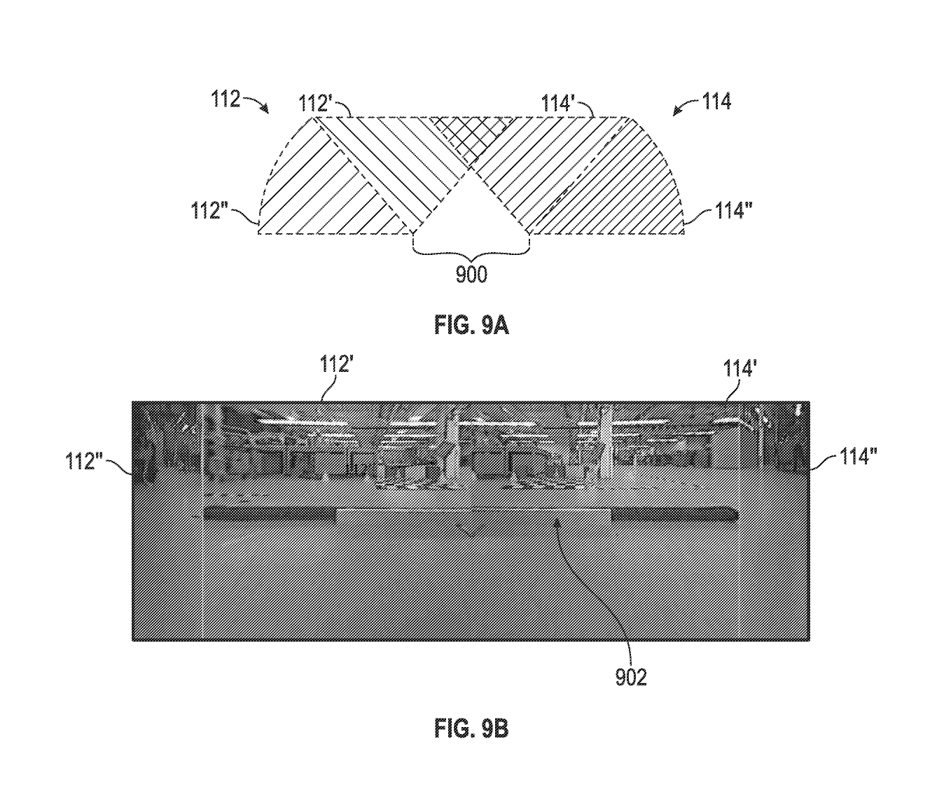

FIGS. 9A and 9B illustrate another embodiment where the FOVs are merged into a single virtual image. In this embodiment, the side regions indicated at 900 are discarded and the FOVs 112 and 114 are merged to overlap slightly as shown. This presents a sharp single image to the operator of the vehicle. However, due to the discarding of two of the side regions, note that an area (802 of FIG. 8B) in front of the curb 902 is missing from the virtual image and also a double image is shown for objects in the overlapped region. However, additional processing may be applied to alleviate the missing and double images. Non-limiting examples of such processing include utilizing sensed geometry from a LIDAR sensor or estimated depth information from stereo vision processing method for a virtual scene rendering and applying a image-based rendering techniques to render a virtual image view based on multiple camera inputs.

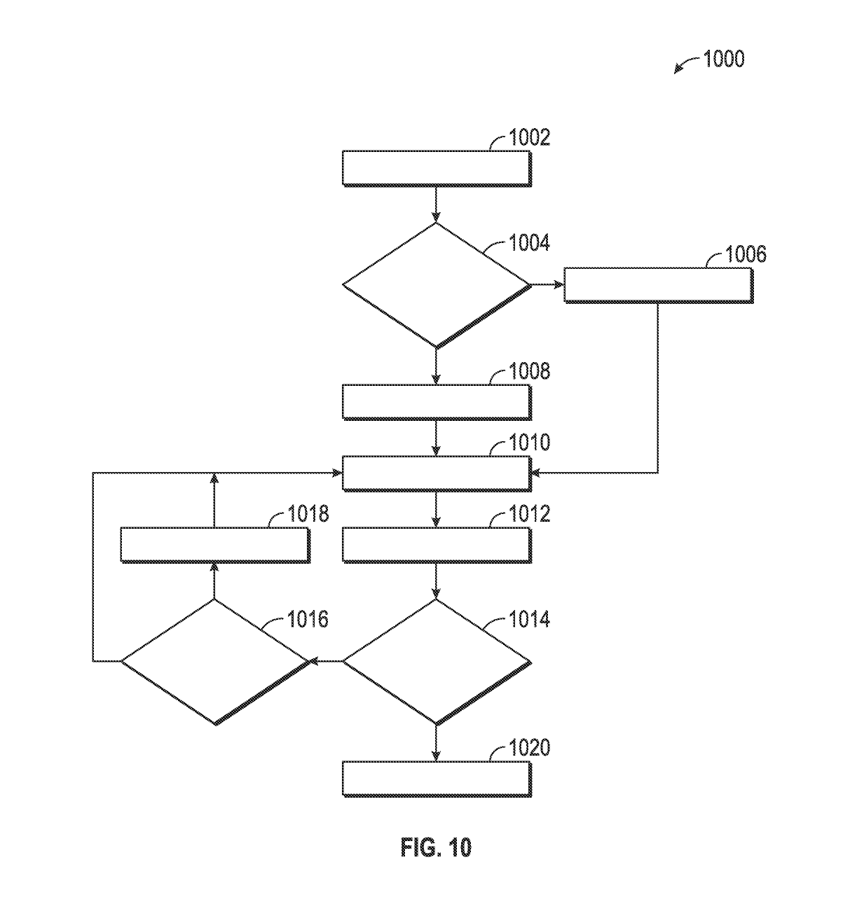

FIG. 10 illustrates flow diagrams useful for understanding the dual camera front curb viewing system disclosed herein. The various tasks performed in connection with the method 1000 of FIG. 10 may be performed by software, hardware, firmware, or any combination thereof. For illustrative purposes, the following description of the method of FIG. 10 may refer to elements mentioned above in connection with FIGS. 1-9. In practice, portions of the method of FIG. 10 may be performed by different elements of the described system. It should also be appreciated that the method of FIG. 10 may include any number of additional or alternative tasks and that the method of FIG. 10 may be incorporated into a more comprehensive procedure or process having additional functionality not described in detail herein. Moreover, one or more of the tasks shown in FIG. 10 could be omitted from an embodiment of the method of FIG. 10 as long as the intended overall functionality remains intact.

The routine begins in step 1002 where the system is activated to begin presenting front view images of any curb or other obstruction in front of the vehicle. The system may be active manually by the user, or automatically using any number of parameters or systems. Non-limited examples of such automatic activation include the vehicle speed being below a certain threshold (optionally in conjunction with the brakes being applied); any of the collision avoidance systems employed (e.g., vision-based, ultrasonic, radar based or LIDAR based) detecting an object (e.g., curb) in front of the vehicle; braking begin automatically applied such as by a parking assist system; the GPS system indicating that the vehicle is in a parking lot or parking facility or by any other convenient method depending upon the particular implementation. Next, decision 1004 determines whether the driver has selected a preferred display mode. According to exemplary embodiments, any or all of the virtual image techniques may be used in a vehicle and the user (driver) may select which preferred virtual image should be displayed. If decision 1004 determines that the user has made such a selection, the de-warping technique associated with the user's selection is engaged (step 1006). However, if the determination of decision 1004 is that no selection has been made, a default selection is made in step 1008 and the routine continues.

Step 1010 captures and de-warps images from the dual cameras (102, 104 in FIG. 1) for the controller (116 in FIG. 1) to display (such as on the display of FIG. 1) in step 1012. After each image is displayed in step 1012, decision 1014 determines whether the system has been deactivated. Deactivation may be manual (by the driver) or may be automatic such as by detecting that the vehicle has been placed into Park. If the vehicle has parked, the routine ends (step 1020). However, if the vehicle has not yet parked, decision 1016 determines whether the user has made a display change selection. That is, the user may decide to change viewing modes (and thus de-warping models) during the parking maneuver. If the user has made a new selection, step 1018 changes the de-warping modeling employed. If no user change has been made, the routine loops back to step 1010 and the routine continues to capture, de-warp and display driver assisting images of any frontal obstruction that may cause damage to the vehicle during the parking maneuver.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth herein.

What is claimed is:

1. A method, comprising:
capturing a first real image from a first camera having a forward-looking field of view of a vehicle;
capturing a second real image from a second camera having a forward-looking field of view of the vehicle;
de-warping and combining the first real image and the second real image in a processor to form a curb view virtual image view in front of the vehicle; and
displaying the curb view virtual image view on a display within the vehicle.

2. The method of claim 1, wherein the curb view virtual image comprises a top-down virtual image or a perspective-view virtual image.

3. The method of claim 1, wherein:
capturing the first real image comprises capturing the first real image from the first camera having an approximately 180 degree field of view; and
capturing the second real image comprises capturing the second real image from the second camera having an approximately 180 degree field of view.

4. The method of claim 1, wherein de-warping the first real image and the second real image comprises the processor applying a planar de-warping process to form the curb view virtual image.

5. The method of claim 1, wherein de-warping the first real image and the second real image comprises the processor applying a non-planar de-warping process to form the curb view virtual image.

6. The method of claim 1, wherein dewarping the first real image and the second real image comprises the processor applying a combined planar and non-planar dewarping process to form the curb view virtual image.

7. The method of claim 1, wherein combining the first real image and the second real image comprises the processor applying a weighted average process over an overlapping portion of the first real image and the second real image.

8. The method of claim 1, further comprising the processor overlaying a graphic image with the curb view virtual image to provide distance information to the curb view virtual image.

9. The method of claim 1, further comprising the processor receiving a display mode instruction and applying a de-warping processes corresponding to the display mode instruction to the first and second real image to form the curb view virtual image.

10. The method of claim 1, further comprising automatically deactivating the first and second cameras after the vehicle has been placed into park.

11. A system, comprising:
a first camera having a forward-looking field of view of a vehicle to provide a first real image;
a second camera having a forward-looking field of view of the vehicle to provide a second real image;
a processor coupled to the first camera and the second camera and configured to de-warping and combine the first real image and the second real image to form a curb view virtual image view of a front of the vehicle; and
a display for displaying the curb view virtual image within the vehicle.

12. The system of claim 11, wherein the first camera and the second camera each have an approximately 180 degree field of view.

13. The system of claim 11, wherein the curb view virtual image comprises a top-down virtual image or a perspective-view virtual image.

14. The system of claim 11, wherein the first camera and the second camera each have an optical axis offset from a forward direction of the vehicle.

15. The method of claim 11, wherein the processor applies a planar de-warping process to form the curb view virtual image.

16. The system of claim 11, wherein the processor applies a non-planar de-warping process to form the curb view virtual image.

17. The system of claim 11, wherein the processor applies a combined planar and non-planar de-warping process to form the curb view virtual image.

18. The system of claim 11, wherein the processor applying a weighted average process over an overlapping portion of the first real image and the second real image.

19. The system of claim 11, further comprising the processor overlaying a graphic image with the top-down virtual image to provide distance information to the curb view virtual image.

20. A vehicle, comprising:
a first camera having a forward-looking field of view of a vehicle to provide a first real image;
a second camera having a forward-looking field of view of the vehicle to provide a second real image;
a processor coupled to the first camera and the second camera and configured to:
de-warp the first real image and the second real image using a planar process, a non-planar process or a combined planar and non-planar process to provide a de-warped first and second images;
combine overlapping portions of the first and second de-warped images to provide a curb view virtual image of a front of the vehicle; and
overlay a graphic image to the curb view virtual image to provide distance information; and
a display for displaying the curb view virtual image and graphic overlay within the vehicle.

21. The vehicle of claim 20, wherein the curb view virtual image comprises a top-down virtual image view.

22. The vehicle of claim 20, wherein the curb view virtual image comprises a perspective virtual image view.
